(19) United States
(12) Patent Application Publication
(10) Pub. No.: US 2005/0242017 A1
(43) Pub. Date: Nov. 3, 2005

(54) Microfluidic devices for liquid chromatography and mass spectrometry

(76) Inventor: Sau Lan Tang Staats, Hockessin, DE (US)

Correspondence Address: DARBY & DARBY P.C., P. O. BOX 5257, NEW YORK, NY, 10150-5257, US

(21) Appl. No.: 11/108,014

(22) Filed: Apr. 14, 2005

Related U.S. Application Data
(60) Provisional application No. 60/562,615, filed on Apr. 15, 2004.

(51) Int. Cl. B01D 15/08

(52) U.S. Cl. 210/198.2; 422/70; 324/318

(57) ABSTRACT

In one aspect, a microfluidic device includes a substrate with a top surface and a raised channel architecture in which at least one channel is formed and defined across a top surface of the substrate and between raised side walls such that a floor of the channel is coplanar with the top surface. The device has a cover positioned over the substrate in alignment with the substrate and including a seal portion that is sealingly received between the raised side walls so as to seal the at least one channel. In addition, the device includes a column packing material disposed within the at least one channel between the raised side walls prior to sealing the at least one channel by merely only inserting the seal portion of the cover within the at least one channel between the raised side walls.

### CROSS-REFERENCE TO RELATED APPLICATION

The present application claims the benefit of U.S. patent application Ser. No. 60/562,615, filed Apr. 15, 2004, which is hereby incorporated by reference in its entirety.

### TECHNICAL FIELD

This present invention relates to three-dimensional microfluidic devices that integrate macroscopic features as well as microscale structural components to form useful microfluidic elements for chromatographic separation with novel chromatographic packing materials and for interfacing with mass spectrometry. Microfluidic elements are further integrated into useful formats such as that of a microtiter plate. The whole device can be seamlessly integrated with existing, widespread sample dispensing robotics to enable full laboratory automation. The devices can be fabricated by injection-molding technology. The preferred materials for fabrication are thermal plastics. In other words, the components, including the substrate and the cover, that form the microfluidic device can be in the form of injection molded parts.

### BACKGROUND

The dramatic increase in the number of possible protein targets due to the success of the Human Genome Project, and the improvement of the number and the quality of the library compounds create unprecedented demand on high throughput screening operations in drug discovery. The key to boost productivity is to provide fast, efficient, non-radiometric assay systems that are miniaturized, accurate, and have relatively fast assay development procedures.

In the area of proteomics, 2D gel electrophoresis has been the predominant technique for analyzing the protein constituents of whole cells and cell organelles in the past 20 years. 2D gel electrophoresis separates proteins based on molecular weight along one dimension and isoelectric pH along the other dimension. However, an important class of proteins, the post-translationally modified proteins, may be difficult to discern by this method. Post-translational modification is far more common than had once been thought, which greatly complicates the already imposing task of analytical methods in proteomics. Most post-translational modifications, such as phosphorylation and acetylation, are associated with a change in charge, making them amenable to separation along the pI axis in 2D gels. Glycosylation imparts only a slight change in molecular weight, and the increased adhesiveness of the protein gives additional zone broadening. Proteins can be multiply-glycosylated, and differing levels of glycosylation typically give rise to broad smears in the 2D gels, rather than isolated spots corresponding to each modified protein. The extent of glycosylation of proteins is broadly important in controlling signal and cell-cell recognition. For hemoglobin, the extent of glycosylation is correlated with diabetes or prolonged stress. The ability to analyze glycosylation levels of proteins would allow advances in the understanding of this important process. Today's techniques are unsatisfactory for characterizing glycosylation.

The combination of high resolution liquid chromatography LC and mass spectrometry (MS) has emerged as the technique of choice in more and more drug discovery and proteomic studies. By implementing these techniques in a microfluidic device, high speed, extremely high sensitivity MS measurements without sample cross contamination, and require ˜μL or less of samples will be made possible, especially after the preconcentration step made by extremely high resolution liquid chromatography.

The microfluidic avenue for miniaturization promises also to address the problems of labor-intensiveness in proteomics. The potential to integrate multiple analytical and sample preparation steps in a single device is a promising approach to solve the problem of sample preparation, separation, detection and identification of the small amounts of post-translational modified proteins in the complex matrix of cellular content. In spite of the great progress made in microfluidics and recent commercialization of a few applications in DNA separation and protein crystal growth, the flat, two-dimensional microfluidic devices currently in use do not interface well with the existing automation equipment, and the cost and limitation of fabricating these devices through clean-room facilities and high temperature bonding of substrates severely hinder the general acceptance of these devices. Moreover, the two-dimensional nature of these devices also presents difficulty interfacing with mass spectrometry, the most powerful protein identification technique.

### SUMMARY

In one aspect, a microfluidic device includes a substrate with a top surface and a raised channel architecture in which at least one channel is formed and defined across a top surface of the substrate and between raised side walls such that a floor of the channel is coplanar with the top surface. The device has a cover positioned over the substrate in alignment with the substrate and including a seal portion that is sealingly received between the raised side walls so as to seal the at least one channel. In addition, the device includes a column packing material disposed within the at least one channel between the raised side walls prior to sealing the at least one channel by merely only inserting the seal portion of the cover within the at least one channel between the raised side walls.

In another aspect, the present invention is a device that provides a two-dimensional format of parallel channels allowing multilane chromatographic separations of proteins and other biomolecules by means of gradient elution liquid chromatography using column packing material for the separation. The general features of three-dimensional channels making up the two-dimensional separation device have been previously disclosed in U.S. patent application Ser. No. 10/213,202, which is hereby incorporated by reference in its entirety. The channel is formed by a top and bottom substrates. The unique distinction of this channel is that the top substrate acts as a lid that inserts tightly into the open channel of the bottom substrate. The bonding and sealing of the top and bottom substrates is primarily through a simple mechanical interference. One aspect of the present invention is that the open channel, prior to the insertion of the lid for sealing, may be packed with column materials. In one embodiment of the invention, the channel may be packed by self-assembled particles such as silicon oxide nano-particles known in the art. FIGS. 1(a), 1(b) and 1(c) schematically show the sequence of events in the process of packing and sealing a device with four open three-dimensional channels. By contrast, the widely used glass microfluidic channel must be bonded and sealed by a precise high temperature, high-pressure process in a clean room environment. Such an enclosed channel is not compatible with the self-assembled layer formation process, which typically involves the dipping of a substrate at a particular angle into a colloidal solution of nano-particles, as illustrated as an example in FIG. 2. Instead the colloidal particles must be pumped through high pressure into the enclosed channel, destroying the self-assembly advantages. In another embodiment of the invention, the packing material is formed by monolithic interdigitated microscale pillars or posts as shown in FIG. 3. These microscale pillars are integrated structures of the top and bottom substrates. Since channels may be spaced 1 to 2 mm apart, over 100 channels with packing materials may be incorporated into a device that has the width dimensions of a 2D slab gel. The preferred manufacturing technology of the channels is injection molding which does not place a severe limit on the width of the device. By contrast, microfluidic channels manufactured on glass are limited to a few cm in width because of constraints set by clean room equipment.

The materials suitable for making the substrates are thermal plastics. Polyethylene-norbornene co-polymer is particularly suitable because it is UV-transmissive down to 220 nm, which allows UV absorbance or fluorescence to be the detection technologies of the separated peaks. Alternatively, polyalkanes, polyaltylterethphalate, polymethylmethacrylate (PMMA) can be used, or polycarbonate, polystyrene, polyor ionomers, such as Surlyn® and Bynel®, can also be used.

The present device is used for liquid chromatography. Each channel described above is connected to reservoirs, or wells at one end of the channel through an interface plate, and a detection device at the other end of the channel. FIG. 4 shows a schematic drawing of the parts of a single liquid chromatographic microfluidic unit. These separate parts, when assembled through an insert-receptacle mechanism, will allow the performance of liquid chromatography. FIG. 5 is an illustration of the end of a channel shaped as an insert that can be pushed into the receptacle end of a nanospray nozzle for mass spectrometry detection. The reservoirs and the reservoir openings are co-axial with the channels, and are connected to the channel through an interface face that allows multiple reservoirs to connect to a single channel. The detector may be a cell for optical spectrophotometry based on ultra-violet absorption spectroscopy, or laser-induced fluorescence spectroscopy, or it may be a nanospray nozzle for mass spectrometry, or it may be a device containing both of these detection methods.

The units are conveniently fabricated on substrates such that a linear array of these units is formed, as illustrated in FIG. 6. The linear array of liquid chromatographic units are further stacked to conform to a microtiter plate format, i.e., a rectangular arrays of liquid chromatographic units that have the same arrangement of sample wells as a microtiter plate. Since each channel has to be connected to more than one reservoir so that the sample to be separated and the organic and aqueous buffers used for the chromatographic separation can be accommodated. Hence for an 8×12 (96-well microtiter plate) format with 96 channels, the convenient number of reservoirs for each channel is 4 so that the reservoirs can be arranged as in a 384-well microtiter plate format. FIG. 4 is a schematic drawing showing the essential parts of the device but without showing the outline of each top and bottom substrates containing a row of channels, the top plate contains 384 wells (4.5 mm spacing between wells) that are compatible with the liquid dispensing robotics. Four reservoirs are connected to each channel for separation or other functions such as desalting: the smaller two reservoirs for samples and the larger two for run buffers. Further, the other end of each channel is connected to a nanospray nozzle or mass spectrometry analysis. This device may be termed “lab-on-a-microtiter-plate”, or “LOMP”. The various parts of the separation device may be fabricated separately and assembled through mechanical interconnecting elements exemplified by the insert-receptacle mechanism.

### BRIEF DESCRIPTION OF THE DRAWINGS FIGURES

FIG. 1a is a perspective view of one exemplary microfluidic device with a bottom substrate having open channels defined by three-dimensional partitions

FIG. 1b is a perspective view of the device of FIG. 1a with colloidal nano-particles packed into the open channels using conventional deposition methods for self-assembled minelayer, with the shaded regions representing the self-assembled nano-particles

FIG. 1c is a perspective view of the device of FIG. 1a with a lid being inserted after the channels have been packed, with the lid fitting tightly between the channel partitions of the open channels is pressed into a bottom substrate to form a device with liquid-tight enclosed channels;

FIG. 2 is a schematic illustration of a typical method for depositing self-assembled layers of nano-particles on a substrate;

FIG. 3 is a perspective view, in partial cross-section, of a separation channel with microscale posts acting as column material, with the tapered posts associated with the lid insert being disposed between tapered posts associated with the bottom of the bottom channel, thus making these posts interdigitated;

FIG. 4 is a perspective view of components of a microfluidic liquid chromatography unit consisting of the reservoirs, interface plate for connecting the reservoirs to the microfluidic channel, the microfluidic channel for separation, and the detection device which is a nanospray nozzle for mass spectrometry in this case;

FIG. 5 is a perspective view showing the details of the insert-receptacle connection mechanism, wherein the insert is the protruding end of the channel shaped liked a truncated cone that is pushed into a receptacle of the same shape and size on the nanospray nozzle so as to make a liquid-tight junction between the channel and the nanospray nozzle;

FIG. 6 is a perspective view of a linear array of eight microfluidic liquid chromatography units consists of eight channels connected to eight 4-reservoir sets through the interface plate, and to eight nanospray nozzles at the other end of the channels, wherein the channels, the interface plate, the reservoirs and nanospray nozzles are n their own substrates and are assembled together through the insert-receptacle mechanism; and

FIG. 7 is a perspective view of stacking 12 linear arrays of the eight microfluidic liquid chromatographic units, which results in a reservoir layer that has 4×96 wells in the standard 384 microtiter plate format.

### DETAILED DESCRIPTION OF PREFERRED EMBODIMENTS

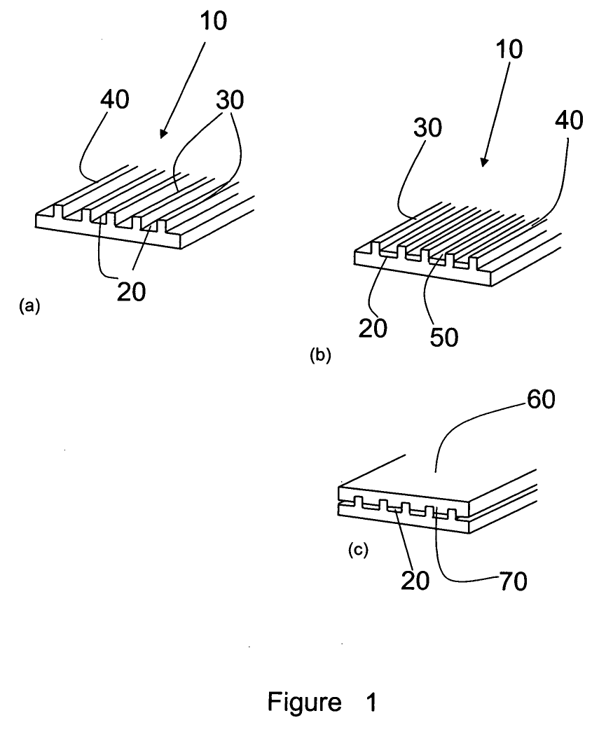

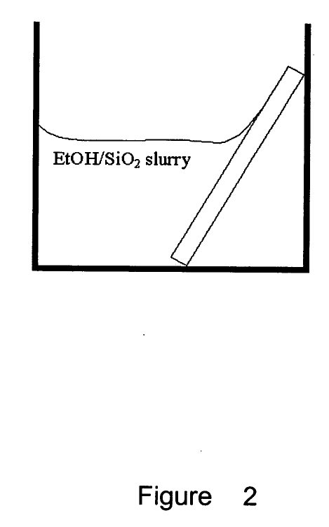

Referring to FIG. 1(a), a substrate 10 contains four open channels 20 which are defined by walls 30 which may be vertical with respect to the channel bottom, or may be at an angle larger than 90 degrees. This substrate is fabricated by injection molding of plastic. The width of the channels is about 250 μm, but may be from 100 to 1000 μm, or to larger than 1000 μm if the application demands it. The length of the channel may be from a few cm to over 10 cm. The width of the raised walls of the channel may be from 0.5 mm to several mm, and the height of the walls may be from 0.5 mm to several mm. In one embodiment, the top of the wall 40 may be co-planar with the surface of the substrate, and the bottom of the channel is beneath the surface of the substrate. In another embodiment, as shown in FIG. 1, the top of the wall 40 is above the surface of the substrate 10 and the bottom of the channel is co-planar with the surface of the substrate 10. In FIG. 1(b), the channels are filled with a column packing material, preferably layers 50 of self-assembled SiO2 nano-particles to a depth of about 10 μm. FIG. 2 shows a schematic way to deposit the nano-particles into the channel. The dipping of a flat substrate into a colloidal solution of the particles at a predetermined angle to create self-assembled monolayers and multilayers are known in the art. In this invention, the flat substrate is replaced by the channel-containing substrate. In order to prevent nano-particles to self-assembled onto the side walls of the channel, the bottom of the channel will have been chemically treated to increase its affinity for the self-assembled layer formation process. One example of surface treatment is oxidation of the channel bottom by ozone or a plasma. To confine the surface treatment to just the channel bottom, a conventional masking and photolithography process can be used to cover the walls with a sacrificial polymer layer which can be stripped after the self-assembled layer formation process. Once the nano-particles have been packed in the channels, the substrate that acts as a lid 60 with insert structures 70 typically only a few μm larger than the channel width is placed on the channel-containing substrates and the insert structures pushed in between the two walls of each channel, as shown in FIG. 1(c). The bottom of the insert structures is pressed against the top of the self-assembled layers, and the walls of the insert structure and the channel walls form a mechanical interference fit that is liquid tight and can withstand the pressure generated during liquid chromatography, i.e., up to 10's of atmospheres of pressure. To ensure that the lid will withstand the pressure, external clamping or bonding of the two substrates at the walls may be applied.

The self-assembled nano-particles inside the channel provide very high surface area for chromatography, and since the particles are lodged in stationary layers, no frit is needed for retaining the particles inside the channel during chromatography. These nano-particles may be chemically modified as in conventional silica particles widely used in liquid chromatography in order to improve the separation efficiency.

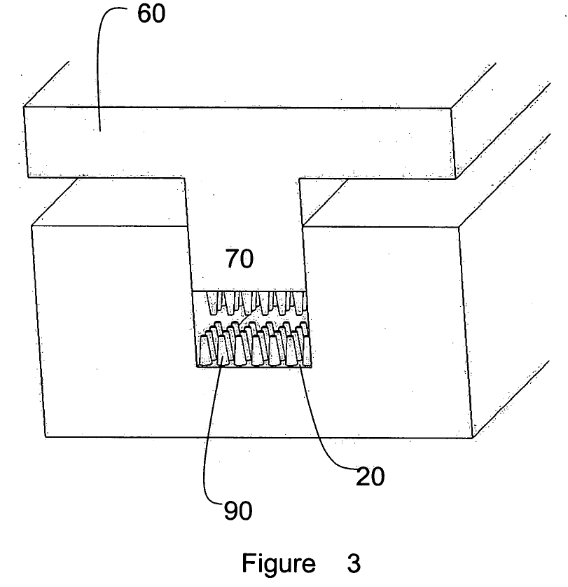

In another embodiment of the invention, the column packing material is formed by fabricating tapered pillars or posts on both the bottom of the channel and the bottom of the insert structures in the channel. Referring to FIG. 3, the pillars 90 are interdigitated. The interdigitation allows higher density of the posts in the channel, which in turn allows higher pressure to be used during chromatography. Since the posts are stationary inside the channel, no flit is needed for the packed column. The interdigitated column packing posts increases the density of the posts and can be made to control voids in the channel. The surface of the column may be chemically derivatized for a specific separation before the lid is put in to seal the channel. An additional major advantage of these monolithic interdigitated posts as column packing material is that the chromatographic columns are made without a separate column packing step which can be time-consuming and the quality of the packing may not be uniform.

To create post structures from a few μm in diameter and up to 25 μm in height requires holes of these dimensions to be made in the mold for injection molding. The electric discharge machining (EDM) method is used to create the holes in the mold for making the posts. Alternatively, the posts may be made in silicon using conventional microfabrication technology, which is suitable for making channels and small posts structures. The dimensions of these posts pose no challenge to this technology. Once the posts have been fabricated, a layer of nickel may be plated over the posts to make them durable enough for EDM. The nickel-plated posts will be used as EDM tooling to make the mold. With this method, the whole channel as well as the posts may be fabricated. Note that the silicon-based microfabrication technology is used for making the EDM tool, but not the device itself since the insert ends of the channel cannot be made in two dimensions.

The size of the posts acting as monolithic column packing and the spacing of these posts may be determined according to applications. For the desalting or a coarse separation/filtering function, the posts can be larger (up to 20 μm in diameter) and spaced further apart to allow a faster flow rate and lower back pressure. At the end of the channel, a nanospray nozzle is attached to the protruding junction of the separation substrates for mass spectrometer interfacing.

The channel with the microscale posts is also of the same three dimensional architecture. The channel size may be from 100 μm to over 1000 μm, and the depth may vary from 10 μm to ten's of μm, and walls that define the width of the channel, and inserts in the lid that define the depth of the channel. The channel with a width of about 300 μm and a depth of about 25 μm has the same cross-sectional area as a conventional 100-μm diameter capillary LC column. Again the channel is sealed primarily by the mechanical interference between the raised walls of the channel bottom and the lid of the channel top. Thermal bonding or/and adhesive bonding may be used to strengthen the seal of the channel to withstand the high pressure used in the separation. The mechanical interference seal should create a channel accurate to a few microns, and is relatively simple to construct.

An ethylene-norbornene copolymer is preferred as the material for the channel because of its good mechanical and optical (transparent down to ˜220 nm) property, which will allow simultaneous optical detection with mass spectrometry if desired. This co-polymer is also inert toward acetonitrile, the most popular organic phase buffer in liquid chromatography.

Each pair of substrates with the packed channels may be used for chromatographic separations using optical and/or mass spectrometry detection for the separated peaks. The number of channels in each pair of substrates may vary from one to over a hundred or more, depending on the size of the substrates, and the spacing of the channels.

The ends of the 3-D channel described in this invention are shaped as inserts to connect the channel to the other parts of the device such as wells used for sample and buffer storage, cells or devices for chromatographic peak detection, etc.

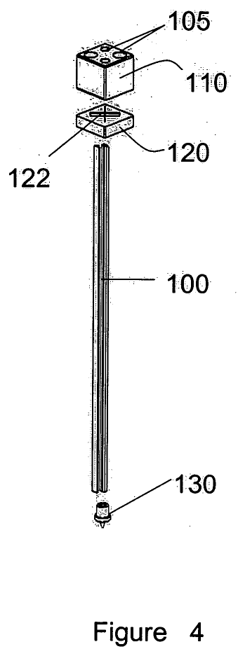

For purpose of illustration, in FIGS. 4-7, a microfluidic channel 100 is illustrated and it will be understood that this channel 100 has an identical or very similar construction as the structure shown in FIGS. 1(a)-1(c) in that in contains substrate 10 defining channel 20 and the cover 60 that seals the channel 20. FIG. 4 is a perspective view of exemplary components of a microfluidic liquid chromatography unit that includes an inlet housing or block 110 that contains a number of reservoirs 105 for receiving the samples (fluids). An interface plate 120 is provided and is configured to connect the reservoirs 105 to the microfluidic channel 100. In FIG. 4, the interface plate 120 has a channel structure 122 that is constructed to direct fluid from up to four reservoirs 105 into a single channel 100. A nanospray nozzle 130 is provided and is fluidly connected to an opposite end of the channel 100. The nozzle 130 can serve as a detection device which in this case is for mass spectrometry, etc.

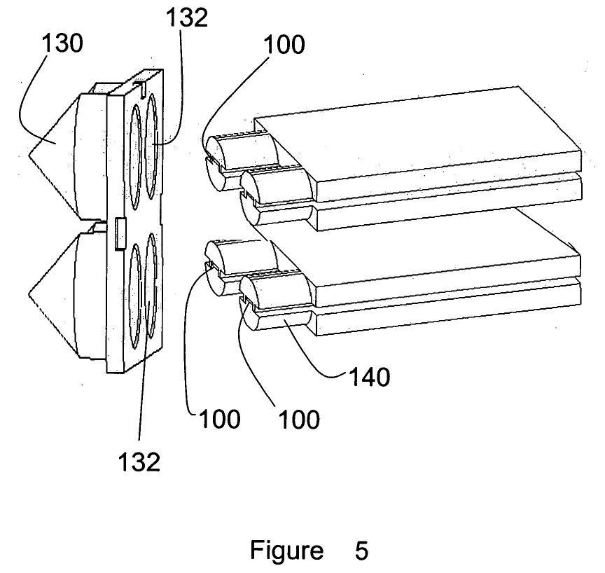

Referring to FIG. 5, the end of the channel 100 in this instance is shaped into a truncated cylindrical member 140, which can be pushed into another part of the device, which in this case is a receptacle 132 of the nanospray nozzle 130. The connection of the channel 100 to the nanospray nozzle 130 can be relatively straightforward. Since the pressure drop between the packed channel 100 and the nozzle opening will be minimal, the junction between the channel 100 and the nozzle 130 can be just an interference fit between the protruding end (cylindrical member) 140 of the channel 100 and the receptacle 132 built in the nanospray nozzle 130. Likewise, the channel end insert 140 may connect to other types of detectors such as an optical detection cell. At the other end of the channel, the end insert 140 of the channel 100 is pushed into the receptacle of an interface plate that allows more than one reservoir to be connected to each channel.

In the embodiment of FIG. 5, four channels 100 are mated with four reservoirs 132 associated with four nanospray nozzles 130. In other words, each channel 100 directs fluid into its own respective nozzle 130 that is mated therewith.

In one embodiment, a piece or inlet block containing four reservoirs (see FIG. 4), the interface plate (see FIG. 4), the separation channel 100, and the nanospray nozzle 130 constitute the component of a microfluidic liquid chromatography unit. Since a liquid chromatography experiment requires the sample to be separated, an organic mobile phase buffer and an aqueous mobile phase buffer to be independently injected into the separation channel from separate reservoirs, the interface plate is needed to direct the flows from the three reservoirs into the microfluidic separation channel 100. The microfluidic liquid chromatography unit is assembled to be functional by connecting the components by inserts and receptacles.

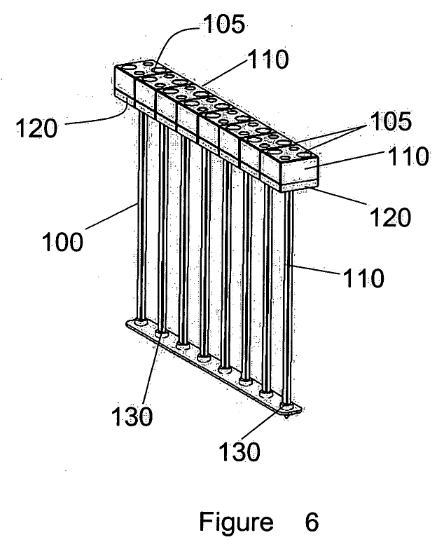

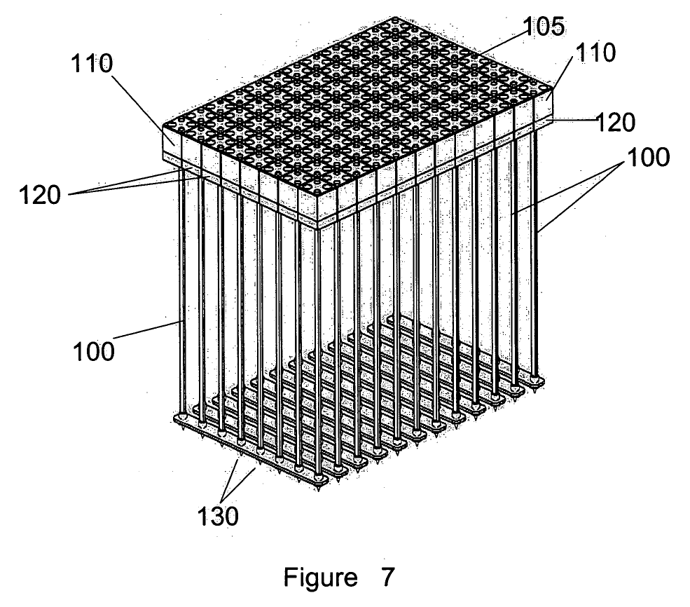

In another embodiment of the invention, the units of the chromatographic separation devices may be arranged into a format such that conventional liquid dispensing robotics may be used to dispense samples and buffers directly into the reservoirs for the separations to achieve very high throughput operations. Since the most wide-spread liquid dispensing robotics is designed for the microtiter plate format, the array of liquid chromatographic units may be assembled into the microtiter plate format. For example, referring to FIG. 6, a strip containing the reservoir blocks 110 with reservoirs 105 formed therein, interface plate 120, and the nanospray nozzles 130 are mated to one 8-channel pair of substrates by means of inserts and receptacles. Each pair of these assembled substrates are then stacked 9 mm apart from channel to channel to 12 layers to form a microtiter plate format, in this case a 384 (4×96)-well, 96 (8×12)-channel-and-nanospray-nozzle unit, as shown in FIG. 7. Multiple reservoirs for storing the sample and buffers are connected to each channel. For a 96-channel plate, one convenient arrangement for the reservoir so that samples and buffers can be dispensed into the reservoirs by conventional robotics is to have four reservoirs spaced at a fixed distance of 4.5 mm (384-well format). Two of the reservoirs are for the organic and aqueous mobile phase buffers respectively. The other reservoirs are for two different samples. The number and arrangement of reservoirs are chosen for a specific number of channels so that the reservoirs are always accessible by the liquid dispensing robotics. The reservoirs are co-axial with the channel, and are connected to the channel through an interface plate with inserts and receptacles There may be many different shapes of inserts and receptacles to achieve a liquid-tight junction capable to resisting 10's of atmosphere of pressure which exists during a liquid chromatographic run.

The 384-microtiter well format allows conventional liquid dispensing robotics to fill the reservoirs with two different samples, an aqueous buffer and an organic buffer. For pumping the samples and buffers to the separation channel, conventional piston pumps may be fitted into the reservoirs. The larger wells for storing the organic and mobile phases will be precision molded to accept a piston for exerting up to 10's of atmosphere of pressure for pumping the mobile phases through the packed channel for the separation. The plastic for this part of the plate is preferably an engineering polymer, e.g. glass-filled nylon or glass-filled polybutyleneterephthalate (PBT), with good mechanical property. Since existing piston pumps use a polymer seal already, the polymeric well should be suitable for use as the barrel for the pump. The liquid samples are pumped through the interface plate connecting the wells to the separation channel.

Alternatively, commercially available pumps for liquid chromatography may be connected to the wells for applying pressure to the buffer and samples in the wells. By using commercial liquid chromatographic pumps which have integrated valves to control the direction of flow of the liquid from each reservoir, no additional valve mechanism is necessary.

A number of assembly steps will be necessary to connect the pieces together. However, since each piece has macroscopic inserts and receptacles, it should be relatively straightforward to automate the assembly. Locating structures such as pins and steps can be used to align the different pieces for ease of assembly.

### EXAMPLES

### Example 1

A microfluidic liquid chromatography device containing two separation channels each connected to three reservoirs at one end and a nanospray nozzle at the opposite end was fabricated by injection molding of the polyethylene-norbornene polymer. The separation channel has the three-dimensional architecture described in this application. The width of the channels is 750 μm wide, and the walls defining the channel width are 0.5 mm high and 0.5 mm wide. Before the top substrate containing the lid inserts was put on the bottom substrate containing the open channels separated by 0.5 mm high walls, the open channel was dipped into a colloidal solution of ethanol/water containing silica particles about 200 nm in diameter. Care was taken to make sure that the silica nano-particles self-assembled only in the open channel area of the substrate. The layers of self-assembled nano-particles were chemically derivatized with a silane solution, and then wash with a solution containing C18 molecules, which are commonly used as stationary phase molecules on column packing particles for liquid chromatographic separations. Many different commonly used methods for attaching the stationary phase molecules onto the silica column packing particles were also possible. The self assembled layered nano-particles were ready for use for reverse phase liquid chromatography. The lid with the inserts was subsequently pressed down on the bottom substrate so that the lid inserts were positioned between the two walls of each channel, and was in contact with the top layer of the multilayered self-assembled particles. A layer of adhesive was put between the top and bottom substrates outside of the seams created by the walls and the lid inserts to ensure a liquid tight seal for the channel even under the pressure typically generated by liquid chromatography. The final channel depth with the self-assembled nano-particles as column packing was 10 μm.

The device was used to separate a tryptic digest of an enzyme glutamate dehydrogenase. The concentration of the digested sample in channel #1 was 200 attomole, and that of the sample in channel #2 was 100 femtomole. The mobile phase buffers were pumped through the two buffer reservoirs with conventional piston pumps used in liquid chromatography. The pump pressure was adjusted to give about a 100 nL/minute flow rate of the mobile phases. The two nanospray nozzles at the end of the two channels were placed about 5 mm from the inlet cone of a mass spectrometer so that each nanospray nozzle was situated on either side of the conical axis of the mass spectrometer inlet. The two mobile phases were mobile phase A: water +0.5% Acetic Acid, mobile phase B: acetonitrile+0.5% Acetic Acid. The chromatography run began in channel #1 with 10% mobile phase B for 15 minutes, followed by a 10%-90% mobile phase B gradient in a 20 minute interval, and then followed by 15 minutes at 90% mobile phase B, then a 2 minute gradient back to 10% mobile phase B. The elutant from channel #1 was sprayed into the mass spectrometer inlet with a voltage of 2.5 KV imposed on the elutant. The mass spectrum recorded the peptide fragments that were separated and detected by the mass spectrometer as a function of time. Immediately after the run in channel #1 was finished, the run in channel #2 was started with the same chromatographic program. The mass to charge ratio of each peak in the two mass spectra was identified, and the sequence of amino acid in each peptide was elucidated using the standard data-base search routine.

### Example 2

A microfluidic liquid chromatographic device in the form of a microtiter plate was fabricated as described in this application. There were 96 (an array of 8×12, spaced 9 mm apart in each direction) channels, and each channel was connected to 4 reservoirs so that the reservoirs have the configuration of a 384-microtiter plate. The channel geometry and construction were the same as that described in Example 1, and the detection technology is nanospray mass spectrometry. 192 samples of a tryptic digest of glutamate dehydrogenase of 192 different concentrations ranging from 1 picomole to 200 attomole were deposited into the sample reservoirs (two per channel) with conventional 384 microtiter liquid dispensing robotics, and the pumping of samples and buffers were through conventional piston pumps. Each channel was used to separate the two samples sequentially. The microfluidic liquid chromatography microtiter plate device was placed in front of the mass spectrometer inlet so that the nanospray nozzle at position A1 at the corner of the 8×12 channel array was directly in front of the mass spectrometer inlet at a distance of 5 mm. After two samples have been separated using the chromatographic method described in Example 1, the whole device is moved by means of motorized stages in three dimensions such that the nanospray nozzle at position A2 was now facing the mass spectrometer inlet. The two samples for this channel were separated sequentially and detected by the mass spectrometer, and the position of the whole device was again moved. These procedures were repeated until all 192 samples had been separated.

1. A microfluidic device comprising:
a substrate with a top surface and a raised channel architecture in which at least one channel is formed and defined across a top surface of the substrate and between raised side walls such that a floor of the channel is coplanar with the top surface;
a cover positioned over the substrate in alignment with the substrate and including a seal portion that is sealingly received between the raised side walls so as to seal the at least one channel; and
a column packing material disposed within the at least one channel between the raised side walls prior to sealing the at least one channel by merely only inserting the seal portion of the cover within the at least one channel between the raised side walls.

2. The device according to claim 1, wherein the raised side walls are formed at right angles to the top surface of the substrate.

3. The device according to claim 1, wherein the seal portion that seals the at least one channel comprises an elongated protrusion that extends from an underside surface of the cover and is dimensioned to be sealingly received between the raised side walls.

4. The device according to claim 1, wherein the column packing material comprises silicon oxide nano-particles.

5. The device according to claim 1, wherein the column packing material is filled within the at least one channel to a depth of at least about 10 μm.

6. The device according to claim 1, wherein a width of the seal portion is slightly greater than a width of the at least one channel so that a frictional sealed fit results between the seal portion and the raised side walls.

7. The device according to claim 6, wherein the seal portion has width that is about 1-3 μm greater than the width of the at least one channel.

8. The device according to claim 1, wherein the column packing material comprises microscale pillars that are formed the floor of the at least one channel and on a bottom surface of the seal portion of the cover such that the microscale pillars face another.

9. The device according to claim 8, wherein the pillars are interdigitated.

10. The device according to claim 8, wherein the pillars have a tapered construction.

11. The device according to claim 8, wherein surfaces of the pillars are chemically derivatized for a specific separation before the cover is sealingly fitted to the substrate.

12. The device according to claim 8, wherein each pillar has a diameter is equal to or greater than 2 μm and has a height equal to or less than 25 μm.

13. The device according to claim 1, wherein the floor of the at least one channel is chemically treated to increase its affinity between the column packing material and the substrate.

14. The device according to claim 5, wherein the chemical treatment is oxidation of the floor of the at least one channel by one of ozone and a plasma.

15. The device according to claim 1, wherein the cover including the seal portion and substrate including the raised side walls are injection molded articles formed from an injection moldable material.

16. The device according to claim 15, wherein the seal portion is formed in a common mold in situ with a cover base portion so that the seal portion is integrally formed therewith, the raised walls being formed in a common mold in situ with the substrate such that the raised walls are integrally formed with an extend outwardly from the substrate.

17. The device according to claim 15, wherein the column packing material is in the form of injection molded surface features formed along the floor of the at least one channel and on a bottom surface of the seal portion of the cover.

18. A microfluidic liquid chromatography assembly comprising:
a microfluidic device including:
a substrate with a top surface and a raised channel architecture in which at least one channel is formed and defined across a top surface of the substrate and between raised side walls such that a floor of the channel is coplanar with the top surface;
a cover positioned over the substrate in alignment with the substrate and including a seal portion that is sealingly received between the raised side walls so as to seal the at least one channel; and
a column packing material disposed within the at least one channel between the raised side walls prior to sealing the at least one channel by merely only inserting the seal portion of the cover within the at least one channel between the raised side walls;
an inlet body containing a number of reservoirs formed therein for receiving fluid;
an interface plate for directing fluid from a plurality of reservoirs into a first end of one or more channels;
a nonospray nozzle in fluid communication with a second opposite end of the at least one channel for discharging fluid therefrom into a piece of equipment.

19. The assembly of claim 18, wherein the cover including the seal portion and substrate including the raised side walls are injection molded articles formed from an injection moldable material, the seal portion being formed in a common mold in situ with a cover base portion so that the seal portion is integrally formed therewith, the raised walls being formed in a common mold in situ with the substrate such that the raised walls are integrally formed with an extend outwardly from the substrate.

20. The assembly of claim 18, wherein the second end of the least one channel includes a reduced diameter protruding portion that is received within an opening formed in the nanospray nozzle so as to create a frictional interference fit therewith.
